(19) United States
(12) Patent Application Publication
(10) Pub. No.: US 2025/0356083 A1
(43) Pub. Date: Nov. 20, 2025

(54) GLOBAL MODELER USING A PROTECTION ARCHITECTURE

(71) Applicant: Wells Fargo Bank, N.A., San Francisco, CA (US)

(72) Inventors: Lauren Gray Bergsland, Plymouth, MN (US); Anthony Amodeo, San Francisco, CA (US); Christi Lloveras, San Francisco, CA (US)

(73) Assignee: Wells Fargo Bank, N.A., San Francisco, CA (US)

(21) Appl. No.: 18/666,729

(22) Filed: May 16, 2024

(51) Int. Cl. G06F 30/27

(52) U.S. Cl. CPC G06F 30/27

(57) ABSTRACT

Systems, methods, and computer-readable storage media for global modeling. One system includes a first data structure, a second data structure, a machine learning (ML) system and a processing circuit. The processing circuits includes one or more processors and memory storing instructions that, when executed, cause the processing circuit to determine trends corresponding to the one or more accounts for a third-party entity of the plurality of entities and transaction types. The instructions further cause the processing circuit to receive a request for a report. The instructions further cause the processing circuit to retrieve an exchange history. The instructions further cause the processing circuit to determine the corresponding data item. The instructions further cause the processing circuit to generate the report according to the request, the report including a content item including information corresponding to the trend map for the subset of third-party entities.

### BACKGROUND

In a computer networked environment, users and entities like individuals or companies, may desire to model data to improve the protection of data and future exchanges.

### SUMMARY

Some arrangements relate to a system including a first data structure configured to maintain a first dataset, the first dataset including, for a plurality of entities, an entity name, and an entity identifier and a second data structure configured to securely maintain a second dataset, the second dataset including, for the plurality of entities, one or more accounts associated with an entity. The system can further include a machine learning (ML) system and a processing circuit including one or more processors and memory storing instructions that, when executed, cause the processing circuit to determine trends corresponding to the one or more accounts for a third-party entity of the plurality of entities and transaction types, wherein, to determine the trends, the processing circuit is configured to generate, by the ML system, a trend map associated with the third-party entity according to a set of trend indicators determined for the third-party entity, the trend map identifying trends corresponding to the one or more accounts for the third-party entity and transaction types and store an association between the trend map and corresponding data item for the third-party entity in the first dataset. The instructions can further cause the processing circuit to receive, from a user device associated with a first entity of the plurality of entities, a request for a report for a plurality of transactions of the first entity with a subset of third-party entities. The instructions can further cause the processing circuit to retrieve, from an enterprise resource of the first entity, a transaction history for the plurality of transactions with the subset of third-party entities, the transaction history including identifying information relating to a respective third-party entity of the subset. The instructions can further cause the processing circuit to determine, for each of the subset of third-party entities, the corresponding data item in the first dataset. The instructions can further cause the processing circuit to generate, by the ML system, the report according to the request, the report including a content item including information corresponding to the trend map for the subset of third-party entities.

In some arrangements, the system further includes a storage system configured to store the first data structure and the second data structure and wherein the ML system includes at least one first ML model trained to match third-party entities with corresponding data items of the first dataset and determine a predicted account of the one or more accounts for a corresponding transaction, and at least one second ML model trained to generate the content item identifying one or more recommendations.

In some arrangements, the transaction history includes a payment type for each of the plurality of transactions, and wherein to generate the report, the ML system is configured to determine, based on to the trend map for the respective third-party entity of the plurality of entities, a previous payment type used in prior transactions of the respective third-party entity, determine, based on a subset of the plurality of transactions between the first entity and the respective third-party entity, the payment type used for the subset of plurality of transactions and generate the report to identify usage by the respective third-party entity of the previous payment type.

In some arrangements, the instructions further cause the processing circuit to transmit, to a device corresponding to the respective third-party entity, an enrollment request for the previous payment type for one or more future transactions between the first entity and the respective third-party entity.

In some arrangements, the instructions further cause the processing circuit to determine at least one of the one or more accounts for the respective third-party entity is maintained by the system of a provider, transmit, to the user device of the first entity, a request to initiate a future payment, using the system of the provider, for a future payment type based on the report, transmit, to the device of the respective third-party entity, the request to initiate the future payment, using the system of the provider, for the future payment type based on the report, and responsive to receiving an acceptance of the request to initiate the future payment from at least one of the first entity or the respective third-party entity, process an on-us payment corresponding to the future payment type by the provider.

In some arrangements, the report includes, for the respective third-party entity, one or more identifiers corresponding to an account of the one or more accounts of the third-party entity maintained in the second data structure, the one or more identifiers indicating a transaction type used for transactions with the account.

In some arrangements, generating the trend map includes the processing circuit being further configured to retrieve, from a respective enterprise resource of at least some of a plurality of entries, a plurality of data entries corresponding to transactions between a respective entity and a plurality of third-party entities, each data entry including transaction information for the transaction and identifying information relating to a respective third-party entity;

In some arrangements, generating the trend map, responsive to retrieving the plurality of data entries, includes the processing circuit being further configured to determine, by the ML system, a match score between each third-party entity and a corresponding data item of the first dataset, based on the identifying information for the each data entry for the respective third-party entity and determine, by the ML system, for a data entry of the plurality of entries, a trend indicator for the third-party entity, the trend indicator identifying an account and a transaction type.

In some arrangements, the processing circuit is further configured to, responsive to the match score satisfying a threshold criteria generate a data item corresponding to the respective third-party entity for storage in the second data structure, the data item including information corresponding to an account used in a transaction with the third-party entity.

Some arrangements relate to a method of global modeling, the method including determining, by one or more processing circuits, trends corresponding to one or more accounts for a third-party entity of a plurality of entities and transaction types, wherein determining the trends includes generating, using at least one first machine learning (ML) model, a trend map associated with the third-party entity according to a set of trend indicators determined for the third-party entity, the trend map identifying trends corresponding to the one or more accounts for the third-party entity and transaction types and storing an association between the trend map and corresponding data item for the third-party entity in a first dataset. The method can further include receiving, by the one or more processing circuits from a user device associated with a first entity of the plurality of entities, a request for a report for a plurality of transactions of the first entity with a subset of third-party entities. The method can further include retrieving, by the one or more processing circuits from an enterprise resource of the first entity, a transaction history for the plurality of transactions with the subset of third-party entities, the transaction history including identifying information relating to a respective third-party entity of the subset. The method can further include determining, by the one or more processing circuits for each of the subset of third-party entities, the corresponding data item in the first dataset. The method can further include generating, by the one or more processing circuits using at least one second ML model, the report according to the request, the report including a content item including information corresponding to the trend map for the subset of third-party entities.

In some arrangements, the method further including storing, by the one or more processing circuits, a first data structure including the first dataset, the first dataset including, for the plurality of entities, an entity name, and an entity identifier, storing, by the one or more processing circuits, a second data structure including the second dataset, the second dataset including, for the plurality of entities, the one or more accounts associated with an entity, and wherein the at least one first ML model is trained to match third-party entities with corresponding data items of the first dataset and determine a predicted account of the one or more accounts for a corresponding transaction, and the at least one second ML model is trained to generate the content item identifying one or more recommendations.

In some arrangements, the transaction history includes a payment type for each of the plurality of transactions, and wherein to generate the report, the method further includes determining, by the one or more processing circuits based on to the trend map for the respective third-party entity of the plurality of entities, a previous payment type used in prior transactions of the respective third-party entity, determining, by the one or more processing circuits based on a subset of the plurality of transactions between the first entity and the respective third-party entity, the payment type used for the subset of plurality of transactions, and generating, by the one or more processing circuits, the report to identify usage by the respective third-party entity of the previous payment type.

In some arrangements, the method further including transmitting, by the one or more processing circuits to a device corresponding to the respective third-party entity, an enrollment request for the previous payment type for one or more future transactions between the first entity and the respective third-party entity.

In some arrangements, the method further including determining, by the one or more processing circuits, at least one of the one or more accounts for the respective third-party entity is maintained by the system of a provider, transmitting, by the one or more processing circuits to the user device of the first entity, a request to initiate a future payment, using the system of the provider, for a future payment type based on the report, transmitting, by the one or more processing circuits to the device of the respective third-party entity, the request to initiate the future payment, using the system of the provider, for the future payment type based on the report, and responsive to receiving an acceptance of the request to initiate the future payment from at least one of the first entity or the respective third-party entity, processing, by the one or more processing circuits, an on-us payment corresponding to the future payment type by the provider.

In some arrangements, the report includes, for the respective third-party entity, one or more identifiers corresponding to an account of the one or more accounts of the third-party entity maintained in the second data structure, the one or more identifiers indicating a transaction type used for transactions with the account.

In some arrangements, generating the trend map includes retrieving, by the one or more processing circuits from a respective enterprise resource of at least some of a plurality of entries, a plurality of data entries corresponding to transactions between a respective entity and a plurality of third-party entities, each data entry including transaction information for the transaction and identifying information relating to a respective third-party entity;

In some arrangements, generating the trend map, responsive to retrieving the plurality of data entries, the method further including determining, by the one or more processing circuits using the first ML model, a match score between each third-party entity and a corresponding data item of the first dataset, based on the identifying information for the each data entry for the respective third-party entity and determining, by the one or more processing circuits using the first ML model, for a data entry of the plurality of entries, a trend indicator for the third-party entity, the trend indicator identifying an account and a transaction type.

In some arrangements, responsive to the match score satisfying a threshold criteria, the method further including generating, by the one or more processing circuits. a data item corresponding to the respective third-party entity for storage in the second data structure, the data item including information corresponding to an account used in a transaction with the third-party entity.

Some arrangements relate to a non-transitory computer readable medium (CRM) including one or more instructions stored thereon and executable by one or more processors to determine trends corresponding to one or more accounts for a third-party entity of a plurality of entities and transaction types, wherein determining the trends includes generating, using at least one first machine learning (ML) model, a trend map associated with the third-party entity according to a set of trend indicators determined for the third-party entity, the trend map identifying trends corresponding to the one or more accounts for the third-party entity and transaction types and storing an association between the trend map and corresponding data item for the third-party entity in a first dataset. Further, the non-transitory CRM having the one or more instructions stored thereon and executable by the one or more processors to receive, from a user device associated with a first entity of the plurality of entities, a request for a report for a plurality of transactions of the first entity with a subset of third-party entities. Further, the non-transitory CRM having the one or more instructions stored thereon and executable by the one or more processors to retrieve, from an enterprise resource of the first entity, a transaction history for the plurality of transactions with the subset of third-party entities, the transaction history including identifying information relating to a respective third-party entity of the subset. Further, the non-transitory CRM having the one or more instructions stored thereon and executable by the one or more processors to determine, for each of the subset of third-party entities, the corresponding data item in the first dataset. Further, the non-transitory CRM having the one or more instructions stored thereon and executable by the one or more processors to generate, using at least one second ML model, the report according to the request, the report including a content item including information corresponding to the trend map for the subset of third-party entities.

In some arrangements, the non-transitory CRM having the one or more instructions stored thereon and executable by the one or more processors to store a first data structure including the first dataset, the first dataset including, for the plurality of entities, an entity name, and an entity identifier, store a second data structure including the second dataset, the second dataset including, for the plurality of entities, the one or more accounts associated with an entity, and wherein the at least one first ML model is trained to match third-party entities with corresponding data items of the first dataset and determine a predicted account of the one or more accounts for a corresponding transaction, and the at least one second ML model is trained to generate the content item identifying one or more recommendations.

### BRIEF DESCRIPTION OF THE DRAWINGS

FIG. 1 is a block diagram depicting an example of a protection architecture, according to some arrangements.

FIG. 2 is a block diagram illustrating an example computing system suitable for use in the various arrangements described herein.

FIG. 3 is a block diagram further illustrating the protection architecture, according to some arrangements.

FIG. 4 is a block diagram further illustrating the protection architecture, according to some arrangements.

FIG. 5 is a flowchart for a method of global modeling, according to some arrangements.

FIG. 6 is a block diagram of an example system using supervised learning, according to some arrangements.

FIG. 7 is a block diagram of a simplified neural network model, according to some arrangements.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Referring generally to the figures, systems, apparatuses, methods, and non-transitory computer-readable media for centralized data protection and fraud reduction are described herein. In some arrangements, a first model can be trained and implemented to generate a trend map. In some arrangements, a second model can be trained and implemented to generate a report including a content item corresponding with the trend map. The first model and second model can provide various technical improvements over existing systems. In many systems, entities and vendors store and maintain sensitive information which can increase fraud potential and resource utilization (e.g., in attempting to secure the sensitive information). The systems, apparatuses, methods, and non-transitory computer-readable media provided herein provide technical improvements over the protection of data by centralizing sensitive information, thereby enhancing security measures and reducing the exposure of data across multiple, potentially vulnerable, platforms. Additionally, entities and vendors can be susceptible to fraud when handling numerous exchanges with varied payment methods and accounts. The systems, apparatuses, methods, and non-transitory computer-readable media provided herein provide technical improvements over the reduction in fraud by utilizing machine learning to detect anomalous behaviors, optimize exchange selection, and secure transactions.

Referring specifically to technical improvements in data protection, the figures, systems, apparatuses, methods, and non-transitory computer-readable media provide centralized data structures that allow improved monitoring and control over sensitive data access. The technical improvements enhance protection by reducing redundant data storage and consolidating information within secure data architectures. These improvements specifically address vulnerabilities inherent in dispersed data storage systems. Accordingly, data protection is improved by the unification of data management protocols within a single framework.

Referring specifically to the reduction in fraud, the figures, systems, apparatuses, methods, and non-transitory computer-readable media provide machine learning models to analyze exchange patterns across the consolidated data structures. The technical improvements detect inconsistencies in exchange flows and map and report them to entities, users, and third-parties. These improvements address the technical issue of fraudulent activity within large volumes of exchange data. Accordingly, fraud is reduced by proactive detection measures integrated into the data management system.

Referring specifically to technical improvements in resource utilizations by entities and vendors, the figures, systems, apparatuses, methods, and non-transitory computer-readable media provided herein improve data processing through the integration of machine learning models. The improvements reduce the overhead associated with manual data analysis and enhance the speed and accuracy of exchange verification processes. These improvements address inefficiencies in resource allocation for data analysis tasks. Accordingly, resource utilization is improved by increasing the speed of aspects of the data analysis process. Thus, the figures, systems, apparatuses, methods, and non-transitory computer-readable media provided herein offer technical advancement in the management and safeguarding of sensitive data by leveraging the structured analytical capabilities of machine learning models, leading to an improved security posture and more efficient data oversight mechanisms.

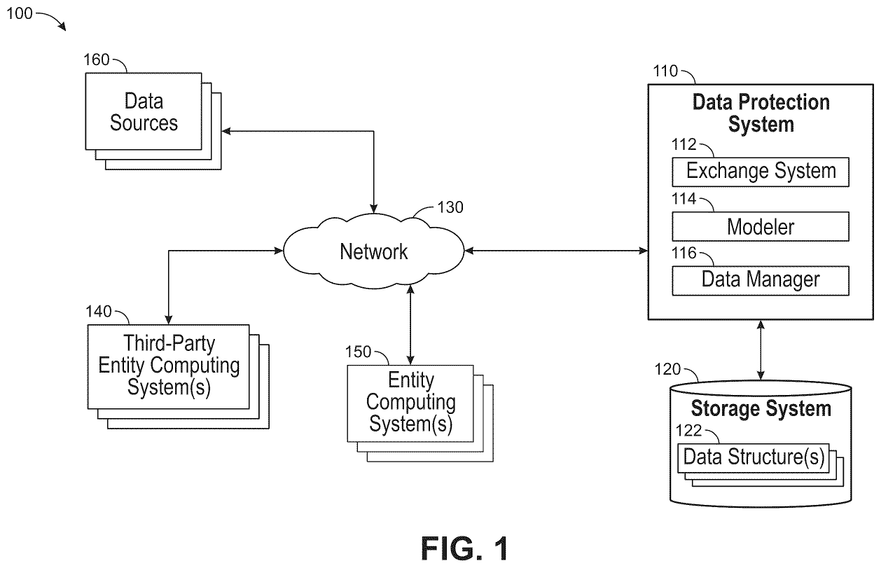

Referring now to FIG. 1, a block diagram depicting an example of a protection architecture 100, according to some arrangements. Protection architecture 100 includes data protection system 110, third-party entity computing systems 140, entity computing systems 150, and data sources 160. In various arrangements, components of protection architecture 100 communicate over network 130. Network 130 may include computer networks such as the Internet, local, wide, metro or other area networks, intranets, satellite networks, other computer networks such as voice or data mobile phone communication networks, combinations thereof, or any other type of electronic communications network. Network 130 may include or constitute a display network. In various arrangements, network 130 facilitates secure communication between components of protection architecture 100. As a non-limiting example, network 130 may implement transport layer security (TLS), secure sockets layer (SSL), hypertext transfer protocol secure (HTTPS), and/or any other secure communication protocol.

The network 130 can facilitate communication between various nodes, such as the data protection system 130, third-party entity computing system 140, entity computing system 150, and data sources 160. In some arrangements, data flows through the network 130 from a source node to a destination node as a flow of data packets, e.g., in the form of data packets in accordance with the Open Systems Interconnection (OSI) layers. A flow of packets may use, for example, an OSI layer-4 transport protocol such as the User Datagram Protocol (UDP), the Transmission Control Protocol (TCP), or the Stream Control Transmission Protocol (SCTP), transmitted via the network 130 layered over an OSI layer-3 network protocol such as Internet Protocol (IP), e.g., IPv4 or IPv6. The network 130 can be composed of various network devices (nodes) communicatively linked to form one or more data communication paths between participating devices. Each networked device includes at least one network interface for receiving and/or transmitting data, typically as one or more data packets. An illustrative network 130 is the Internet; however, other networks may be used. The network 130 may be an autonomous system (AS), i.e., a network that is operated under a consistent unified routing policy (or at least appears to from outside the AS network) and is generally managed by a single administrative entity (e.g., a system operator, administrator, or administrative group).

The data sources 160 can provide data to the data protection system 110. In some arrangements, the data sources 160 can be structured to collect data from other devices on network 130 (e.g., third-party entity computing system 140 and/or entity computing system 150) and relay the collected data to the data protection system 110. In one example, an entity (e.g., users, businesses, and so on) may have, maintain, or otherwise manage a server including, maintaining, or otherwise storing a database (e.g., proxy, enterprise resource planning (ERP) system) that includes account, exchange, and/or payment information associated with the user and/or entity. In this example, the data protection system 110 may request data associated with specific data of the database (e.g., data sources 160) associated with the user or entity. For example, in some arrangements, the data sources 160 can host or otherwise support a search or discovery engine for Internet-connected devices. The search or discovery engine may provide data to the data protection system 110. In some arrangements, the data sources 160 can be scanned to provide additional data. The additional data can include newsfeed data (e.g., articles, breaking news, and television content), social media data (e.g., Facebook, Twitter, Snapchat, and TikTok), geolocation data of users on the Internet (e.g., GPS, triangulation, and IP addresses), governmental databases, generative artificial intelligence (GAI) data, and/or any other intelligence data associated with a specific entity.

As used herein, “protected data” can include sensitive data such as, but not limited to, social security numbers (SSN), employer identification number (EIN), individual taxpayer identification number (ITIN), bank or credit account numbers, passport number, deoxyribonucleic acid (DNA), financial account number, other personal identifying information, biometric information, geolocation data indicating one or more locations of a person or entity, photographs of people, criminal records, credit and/or payment card numbers, health data, and so on. As used herein, “unprotected data” can include data not considered sensitive data. In various arrangements, the data protection system 110 can analyze determine if any protected data is present. In some arrangements, protected data may be designated or marked by the provider (e.g., entity computing system 150).

Generally, the data protection system 110, third-party entity computing system 140, and entity computing system 150 can include one or more logic devices, which can be one or more computing devices equipped with one or more processing circuits that run instructions stored in a memory device to perform various operations. The processing circuit can be made up of various components such as a microprocessor, an ASIC, or an FPGA, and the memory device can be any type of storage or transmission device capable of providing program instructions. The instructions may include code from various programming languages commonly used in the industry, such as high-level programming languages, web development languages, and systems programming languages. The data protection system 110, third-party entity computing system 140, and entity computing system 150 may also include one or more databases for storing data, such as storage system 120, that receives and provides data to other systems and devices on the network 130.

Entity computing system 150 (sometimes referred to herein as a “mobile device”, “user device”, or “client device”) may be a cloud computing system, desktop computing system, mobile computing device, smartphone, tablet, smart watch, smart sensor, or any other device configured to facilitate receiving, displaying, and interacting with content (e.g., web pages, mobile applications, etc.). For example, the entity computing system 150 can be a customer of a provider (e.g., financial institution). Entity computing system 150 can also provide protected and unprotected data to the data protection system 110. For example, protected data could include PCI data, customer account information, accounts payable information. In another example, unprotected data could include an entities name or address. The entity computing system 150 can include an application to receive and display content and to receive user interaction with the content (e.g., report generated by modeler 114). For example, the application may be a web browser. Additionally, or alternatively, the installed application may be a mobile application. The entity computing system 150 can communicate data over network 130 (e.g., receive and transmit protected and unprotected data to data protection system 110).

The third-party entity computing system 140 (sometimes referred to herein as a “mobile device”, “user device”, or “vendor device”) may be a cloud computing system, desktop computing system, mobile computing device, smartphone, tablet, smart watch, smart sensor, or any other device configured to facilitate receiving, displaying, and interacting with content (e.g., web pages, mobile applications, etc.). For example, the third-party entity computing system 140 can be a vendor corresponding with a customer of a provider (e.g., financial institution). In some examples, the vendor may also be a customer of the provider. Third-party entity computing system 140 can also provide protected and unprotected data to the data protection system 110. For example, protected data could include PCI data, vendor account information, accountants receivable information. In another example, unprotected data could include a third-party entities name or address. The third-party entity computing system 140 can include an application to receive and display content and to receive user interaction with the content (e.g., report generated by modeler 114). For example, the application may be a web browser. Additionally, or alternatively, the installed application may be a mobile application. The entity computing system 140 can communicate data over network 130 (e.g., receive and transmit protected and unprotected data to data protection system 110).

Both the third-party entity computing system 140 and the entity computing system 150 can provide data and be accessed by the data protection system 110 using an enterprise resource. In some arrangements, the enterprise resource can be an enterprise resource planning (ERP) system or other enterprise resource that can analyze and manage data flows between systems. For example, the enterprise resource may be configured to facilitate data integration and automation across the organization's operations. In another example, the enterprise resource may be configured to support data security and compliance efforts by monitoring data access and usage.

Generally, the data protection system 110 can be a trained model and data acquisition system configured to protect data of entities and reduce computing resource usage of entities, by providing an exchange network and data protection architecture. The data protection system 110 can interact with the various systems of protection architecture 100 over network 130. In some arrangements, the data protection system 110 can include one or more processing circuits including processor(s) and memory. The memory may have instructions stored thereon that, when executed by processor(s), cause the one or more processing circuits to perform the various operations described herein. The operations described herein may be implemented using software, hardware, or a combination thereof. The processor(s) may include a microprocessor, ASIC, FPGA, etc., or combinations thereof. In many implementations, processor(s) may be a multi-core processor or an array of processors. Memory may include, but is not limited to, electronic, optical, magnetic, or any other storage devices capable of providing processor(s) with program instructions. The instructions may include code from any suitable computer programming language. In some arrangements, the data protection system 110 can include an exchange system 112, modeler 114, and data manager 116.

The data protection system 110 may be a server, distributed processing cluster, cloud processing system, or any other computing device. Data protection system 110 may include or execute at least one computer program or at least one script. In some implementations, data protection system 110 includes combinations of software and hardware, such as one or more processors configured to execute one or more scripts. Data protection system 110 is shown to include storage system 120 (e.g., database, cloud storage). Storage system 120 may store received data. For example, the storage system 120 can include data structures 122 for storing information such as, but not limited to, a plurality of datasets. The datasets can include a plurality of entities, an entity name, and an entity identifier, and additional datasets for the plurality of entities including one or more accounts associated with the entity. In another example, the storage system 120 can include data structures 122 for storing information such as, but not limited to, front end information, interfaces, dashboards, other user or entity information, vendor information, exchange or payment information, invoices, a blockchain ledger, etc. The storage system 120 may be integrated with the data protection system 110, or exist as a distinct component accessible to the data protection system 110, the third-party entity computing system 140, and entity computing system 150 via the network 130. The storage system 120 can also be distributed throughout protection architecture 100. For example, the storage system 120 can include multiple databases associated with the data protection system 110, the third-party entity computing system 140, and/or entity computing system 150. Storage system 120 may include one or more storage mediums. The storage mediums may include but are not limited to magnetic storage, optical storage, flash storage, and/or RAM. Data protection system 130 may implement or facilitate various APIs to perform database functions (i.e., managing data structures 122 stored in storage system 120). The APIs can be but are not limited to SQL, ODBC, JDBC, NOSQL and/or any other data storage and manipulation API.

Generally, the modeler 114 (sometimes referred to herein as a “machine learning (ML) system”) can be an artificial intelligence (AI) system that is trained to identify which account of a vendor is most likely to be used for a particular exchange. In turn, the modeler 114 can generate various recommendations, metrics, and/or trends to identify what type of payment information should be used for a particular vendor. The modeler 114 can be configured to use stored protected data (e.g., in data structures 122) to provide an exchange network to reduce fraud and improve computing resource allocations of entities, vendors, and/or clients. The modeler 114 can be configured to train, retrain, and implement models to provider improved exchange types using protected data stored or housed in the storage system 120. That is, generally, a vendor or entity may store payment identifiers that are truncated for security purposes. When an exchange is desired or requested, the computing systems of the entity or vendor (e.g., third-party entity computing system 140 or entity computing system 150) may untruncate (e.g., restore) the data. However, by untruncating the data, such data may be exposed to the third party, which can result in compromised data integrity and privacy. Accordingly, the modeler 114 can provide improved data and exchange security. Furthermore, the modeler 114 can identify similarities and prompt or initiate an exchange using the exchange system 112 between common customers (e.g., vendor to entity).

In some arrangements, the modeler 114 can be configured to train and implement a machine learning (ML) model (sometimes referred to herein as a “first ML model”) that can match third-party entities with corresponding data items of an entity dataset. Additionally, the modeler 114 can determine a predicted account of the plurality of accounts for a corresponding exchange (or transaction), for example, based on the match. Generally, the first ML model can analyze vendor and entity data to determine a landscape view of vendors (e.g., what accounts are the vendors using, what payment types are the vendor using, and for what exchanges). For example, the third-party entity can be a vendor and an entity can be a client or customer of a provider (e.g., financial institution). In some arrangements, the first ML model can determine trends corresponding to the one or more accounts for a third-party entity (e.g., vendor) of the plurality of entities and exchange types. Determining trends can include retrieving, by modeler 114 from a respective enterprise resource of at least some of the plurality of entries, a plurality of data entries corresponding to exchange between a respective entity and a plurality of third-party entities. That is, the modeler 114 can pull or access exchange information from provider customers or users relating to exchange between the customers and various vendors. For example, the modeler 114 can pull accounts receivables (e.g., AR files) and exchange information (e.g., ACH originating identifier, fed identifier, payment information, vendor files, and so on) from an ERP or other enterprise resource of an entity (e.g., customer or client). In some arrangements, each data entry can include exchange information for the exchange and identifying information relating to a respective third-party entity. In some arrangements, the exchange information can include exchange details and payment methods, and the identifying information can include vendor names and identifiers. For example, the modeler 114 can track payment histories and preferred payment methods for recurring transactions.

Additionally, the first ML model of modeler 114 can determine a match score between each third-party entity and a corresponding data item of a first dataset (e.g., plurality of entities, entity names, entity identifiers) based on the identifying information for the data entry for the respective third-party entity. That is, the modeler 114 can match which vendor is identified in the accounts receivables and exchanges from ERP data to a corresponding vendor in a first data structure (e.g., stored in data structures 122). For example, the modeler 114 can calculate compatibility scores based on frequency and volume of transactions. In another example, the modeler 114 can adjust match scores based on recent activity trends and payment performance.

In some arrangements, responsive to the match score satisfying a threshold criteria, the processing circuits can generate a data item corresponding to the respective third-party entity for storage in the second data structure, the data item including information corresponding to an account used in a transaction with the third-party entity. That is, the threshold criteria could be a predetermined minimum score that indicates a significant degree of interaction and transactional reliability between the entity and the third-party vendor. For example, a threshold could be set such that only vendors with a match score indicating high transaction frequency and low risk are selected. Additionally, the data item could be a composite record including account numbers, transaction dates, amounts, and payment methods. For example, this composite record might encapsulate all relevant financial transaction details necessary for comprehensive reporting and future transactional analysis.

In some arrangements, the first ML model of modeler 114 can determine, for a data entry of the plurality of entries, a trend indicator for the third-party entity, the trend indicator identifying an account and a transaction type. That is, the modeler 114 can determine which accounts are used by a vendor for a particular type of exchange. For example, the modeler 114 can determine identify preferred payment channels for specific services or goods. Furthermore, the modeler 114 can assess risk levels associated with different payment methods can be determined. In another example, the modeler 114 can forecast future exchange behaviors based on historical data.

In some arrangements, the first ML model of modeler 114 can generate a trend map associated with the third-party entity according to a set of trend indicators determined for the third-party entity. That is, the trend map can identify trends corresponding to the one or more accounts for the third-party entity and exchange types. In some arrangements, the trend map can be a landscape view of trends for vendors, which can include mappings of various accounts of the vendors and corresponding exchanges. For example, the trend map can be used to visualize payment patterns and preferences across different industries. In another example, the trend map can highlight emerging trends in payment methods and vendor preferences. Generally, as the first ML model is trained and re-trained, the modeler 114 can be configured to match, using the trend map, vendors across a plurality of entities and determine the vendor exchanges with different entities using different exchange types. That is, the first ML model can facilitate cross-entity comparisons to identify best practices and opportunities for optimization. For example, the first ML model can recommend changes to payment strategies based on trend analysis.

In some arrangements, the first ML model of modeler 114 can store an output—an association between the trend map and the corresponding data item for the third-party entity—in the first dataset in data structure 122 of storage system 120. For example, the output may be or include an association between the trend map and the corresponding data item for the third-party entity. Furthermore, the first ML model can integrate vendor profiles with trend analysis to support outputs, such as recommendations and reports. That is, the modeler 114 can link the landscape view for the vendor to the vendor identifying information in the first directory. In this example, the linking can occur such that, once the first ML model determines that a particular vendor is being used by a customer, the modeler 114 can provide recommendations to the customer (e.g., using the second ML model, described below). Additionally, the first ML model can enhance data granularity to improve model accuracy. Accordingly, the first ML model can receive or identify exchange and vendor data as input and output predictive analytics and recommendations. That is, the first ML model can generate actionable insights based on data modeling.

The first ML model can integrate vendor profiles with trend analysis to support strategic decision-making. That is, the modeler 114 can link the landscape view for the vendor to the vendor identifying information in the first directory. In this example, the linking can occur such that, once the first ML model determines that a particular vendor is being used by a customer, the modeler 114 can provide recommendations to the customer (e.g., using the second ML model, described below). Additionally, the first ML model can enhance data granularity to improve model accuracy. Accordingly, the first ML model can take transactional and vendor data as input and output predictive analytics and recommendations. That is, the first ML model can generate actionable insights based on data modeling. In some arrangements, the first ML model could be, but is not limited to, a deep learning ML model, a reinforcement learning ML model, a supervised learning ML model, an unsupervised learning ML model, or a combination thereof. For example, the first ML model can employ neural networks for pattern recognition and anomaly detection.

In some arrangements, the modeler 114 can be configured to train and implement another ML model (sometimes referred to herein as a “second ML model”) that can receive, from an entity computing system 150 of a first entity, a request for a report for a plurality of exchanges of the first entity with a subset of the plurality of third-party entities (e.g., vendors). Generally, the second ML model can be trained and retrained to communicate with a vendor or particular entity to provide alternatives exchange options. For example, the second ML model of modeler 114 can request a report for entity A on its vendors. In this example, the second ML model can aggregate transactional data and vendor interactions. That is, the second ML model can analyze spending patterns and vendor performance. In another example, the second ML model can offer recommendations for optimizing payment processes and vendor relationships.

In response to receiving the request, the second ML model of modeler 114 can be trained and implemented to retrieve, from an enterprise resource of the first entity, an exchange history for the plurality of exchange with the subset of third-party entities. That is, the modeler 114 can pull or access exchange information from provider customers relating to exchange between the customers and various vendors. For example, the transaction history can include identifying information relating to a respective third-party entity of the subset. In this example, the second ML model can consolidate transaction records and analyze vendor-specific activities. That is, the modeler 114 can pull or access accounts receivables and transaction information from ERP system or other enterprise resource of an entity. For example, the modeler 114 can compile exchange profiles for each vendor.

Additionally, the second ML model of modeler 114 can determine, for each of the subset of third-party entities, the corresponding data item in the first dataset and generate a content item identifying one or more recommendations. That is, for any number of vendor(s) in the accounts receivables, the modeler 114 can determine what is the particular data item in the data structures 122 of storage system 120. For example, the second ML model can link exchange data to specific vendor profiles for targeted insights. In some arrangements, using the second ML model, the modeler 114 can generate a report according to a request. The report could include a content item including information corresponding to the trend map (e.g., generated by the first ML model of modeler 114) for the subset of third-party entities. Accordingly, the second ML model can receive a request, retrieve entity data (e.g., exchange history) corresponding the entity data that can be used as input into the second ML model, and generate a report—the output of the second ML model. In some arrangements, the second ML model could be, but is not limited to, a generative AI (GAI) ML model, a predictive analytics ML model, a decision tree ML model, a cluster analysis ML model, or a neural network. For example, the GAI ML model can generate predictive scenarios based on historical data. In some arrangements, the GAI ML model can identify potential efficiency improvements in vendor interactions. Furthermore, the second ML model can propose alternative strategies for optimizing resource allocation and reducing costs.

In some arrangements, the second ML model may generate the report by determining, based on to the trend map for the respective third-party entity of the plurality of entities, a previous payment type used in prior transactions of the respective third-party entity. For example, the second ML model may identify that a particular vendor consistently used electronic fund transfers for past payments. In some arrangements, the second ML model can generate the report by determining, based on a subset of the transactions between the first entity and the respective third-party entity, the payment type used for the subset of transactions. For example, the second ML model can determine that for all recent transactions with a vendor, the first entity frequently opted for credit transactions. Additionally, the modeler 114 executing the second ML model can model this information to generate a report that reflects and contextualizes the use of these historical payment methods by the third-party entity. This could reveal, for example, a strong preference by a third-party entity for digital wallet services in more recent interactions. The strong preference could be contextualized by the modeler 114 to identify a shift in exchange strategies of the third-party entity.

In some arrangements, the exchange system 112 can be configured to automatically execute or process exchanges based on the request and/or generated report. That is, upon receiving input from the modeler 114, which can include predictive analytics, trend mapping, and specific vendor or entity recommendations, the exchange system 112 can initiate transactions or data exchanges. For example, if the modeler 114 identifies a high probability that a particular vendor account will be used for a transaction based on past behavior and current trends, the exchange system 112 can automatically prepare and initiate the payment process to that vendor account. In some arrangements, automatically executing an exchange can include identifying the most efficient and secure transaction method (e.g., ACH, wire transfer, blockchain-based transaction) based on the transaction's characteristics and the preferences of the involved parties. For example, for a transaction requiring immediate settlement, the exchange system 112 can select a real-time payment method. In another example, for international exchanges, the exchange system 112 can prioritize methods offering lower fees or better exchange rates, while improving compliance with cross-border transaction regulations.

In some arrangements, the exchange system 112 can execute or process an “on-us” exchange between a vendor and an entity having accounts with a particular provider (e.g., the same financial institution). That is, on-us exchanges refer to transactions where both the sending and receiving accounts are within the same banking system or financial institution, which can often be processed quicker and at a lower cost than transactions crossing over to different institutions. For example, if both a vendor and a client are customers of the same bank, an on-us exchange can be executed almost instantaneously, enhancing the cash flow for both parties. Additionally, on-us exchanges can improve the reconciliation process for both entities, as transactions will appear within the same banking system.

In some arrangements, the data manager 116 can be configured to interact with third-party entity computing systems 140, entity computing systems 150, and/or data sources 160 to obtain, validate, and store data within the data structures 122. This can include the initial acquisition of data in addition to ongoing monitoring and updating of data, to reflect real-time or near real-time changes. The data manager 116 can be configured to update the data used by the exchange system 112 and analyzed by the modeler 114 is current, accurate, and comprehensive. In some arrangements, the data manager 116 can pull or access the latest exchange data, updating account information, and incorporating real-time market data or regulatory changes that could impact exchanges. For example, if a new compliance regulation comes into effect that affects certain types of exchange, the data manager 116 can update the data protection system 110. In this example, updating by the data manager 116 can include generating rules or parameters according to the new compliance regulation in real-time (or near real-time). Additionally, the data manager 116 could then apply the rules or parameters to future exchange such that exchanges comply with the regulation. Additionally, the data manager 116 can interact with social media and news feeds to incorporate external data that could impact risk assessments or fraud detection models (e.g., stored on data sources 160).

In some arrangements, the data manager 116 can generate and update a first data structure stored in data structure 122 of storage system 120, which is configured to securely maintain a first dataset. This first dataset can include, but is not limited to, for a plurality of entities, details including an entity name and an entity identifier. For example, the incorporation of previously stored protected data such as account numbers and personal identification numbers (PINs) into this dataset facilitates the data protection system 110 to centralize and enhance the security measures around sensitive information that was once managed independently by entities or vendors. In some arrangements, the data manager 116 can generate and update a second data structure stored in data structure 122 of storage system 120, which can be configured to securely maintain a second dataset. This dataset can include, for the plurality of entities, one or more accounts associated with each entity. For example, by transitioning the storage and management of sensitive account details and transaction histories to the data protection system 110, specifically within the secure apparatus of data structures 122, the data protection system 110 can centralize sensitive financial data and also improve fraud prevention and resource optimization across third-party entity computing systems 140 and entity computing systems 150. This implementation allows for improved data integrity, streamlined access controls, and enhanced analytical capabilities for detecting and responding to potential security threats.

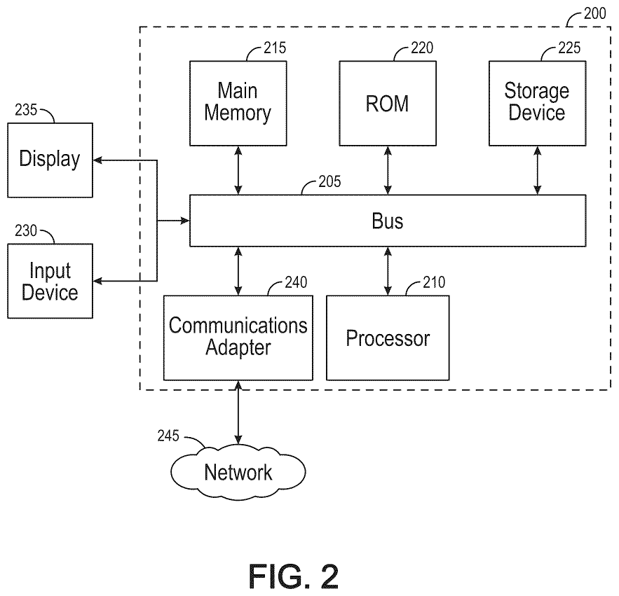

Referring now to FIG. 2, a depiction of a computer system 200 is shown. The computer system 200 that can be used, for example, to implement a computing environment (e.g., protection architecture 100), the data protection system 110, the third-party entity computing systems 140, the entity computing systems 150, the data sources 160, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to facilitate communications with a computing or communications network 245 (similar features and functionality as network 130) and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, virtual server. In various arrangements, computing system 200 may share physical storage, hardware, and other resources with other virtual machines. In some arrangements, virtual resources of the network may include cloud computing resources such that a virtual resource may rely on distributed processing across more than one physical processor, distributed memory, etc.

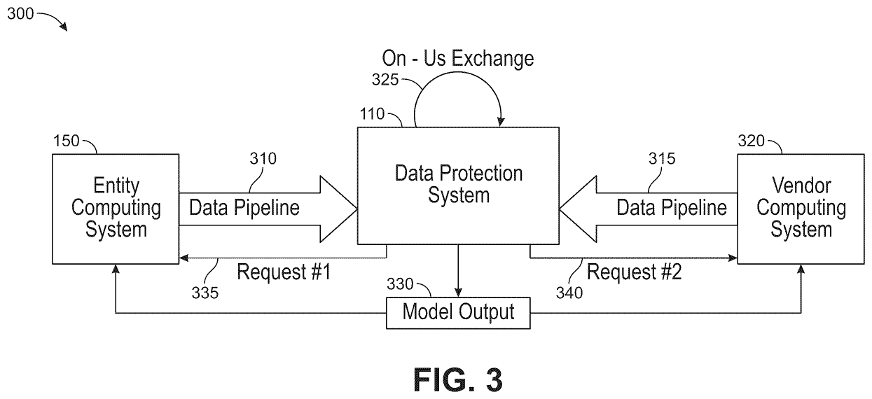

Referring now to FIG. 3, a block diagram further illustrating the protection architecture 100 of FIG. 1, according to some arrangements. The entity computing system 150 and data protection system 110 is described in detail with reference to FIG. 1. Additionally, the vendor computing system 320 can include the same or similar features and functionality of the third-party entity computing system 140 described in detail with reference to FIG. 1. As shown, the entity computing systems 150 and the vendor computing system 320 can provide data via data pipeline 310 and data pipeline 315, respectively. The data pipelines 310 and 315 can be secure and encrypted channels for the transmission of sensitive and protected data (e.g., where data is provided over network 130 of FIG. 1). For example, the pipelines 310 and 315 may utilize encryption standards and transport layer security protocols to allow the integrity and confidentiality of the data transmitted. In some arrangements, the data protection system 110 can execute a first ML model to generate a model output 330 including a trend map. For example, the trend map can identify key patterns and insights related to vendor and entity interactions, highlighting potential areas for optimization or increased security measures. In some arrangements, the data protection system 110 can also execute a second ML model to generate another model output 330 including a report including a content item of information corresponding to the trend map based on a request. For example, this report could offer recommendations for improving transaction security or identifying more efficient payment methods. Accordingly, model output 330 can be utilized to provide strategic implementations and policy updates within the data protection system 110.

In some arrangements, based on the data received from the data pipelines 310 and 315 and modeling by the data protection system 110, the data protection system 110 can perform an on-us exchange 325. That is, the on-us exchange 325 can be based on transactional data and trend insights identified by the ML models, prioritizing exchanges that can be processed internally within the same financial institution or network for efficiency and security. For example, the on-us exchange 325 can be executed or processed after identifying both parties of the transaction as customers of the same financial institution. In another example, the on-us exchange 325 can be executed or processed after verifying the transaction against the trend map for any potential risk factors. Accordingly, the on-us exchange 325 can improve processing times and reduce computational load of entities.

In some arrangements, based on the data received from the data pipelines 310 and 315 and modeling by the data protection system 110, the data protection system 110 can generate a request 335 including an enrollment request or exchange request and provide request 335 to the entity computing system 150 (e.g., entity or client of a provider). For example, request 335 can transmit an enrollment request to the entity computing system 150 for the previously used payment type for one or more future transactions with a specific third-party entity. This improve the exchange processes by pre-approving the payment method, reducing the need for manual entry in subsequent exchange. In another example, request 335 can include a request to automatically initiate an exchange based on predefined conditions, such as reaching a certain transaction volume or date. In this example, the payment could be initiated using an on-us exchange 325 instead of using outside payment rails. Accordingly, request 335 can improve exchange efficiency and security by leveraging historical data and preferences to automate future exchanges.

In some arrangements, based on the data received from the data pipelines 310 and 315 and modeling by the data protection system 110, the data protection system 110 can generate a request 340 including an enrollment request or exchange request and provide request 340 to the third-party entity computing system 140 (e.g., vendor). For example, request 340 can transmit to a vendor computing system 320 corresponding to the vendor an enrollment request for the previous payment type for one or more future transactions with the first entity. This can facilitate an efficient transaction process by establishing a preferred payment method ahead of time. In another example, request 340 can be a request to automatically initiate an exchange upon the fulfillment of specific criteria agreed upon by the vendor and the entity, enhancing operational efficiency and improving timely execution of exchange. In this example, the payment could be initiated using an on-us exchange 325 instead of using outside payment rails. Accordingly, request 340 can streamline the exchange process between entities and vendors, reducing manual intervention and optimizing exchange flows.

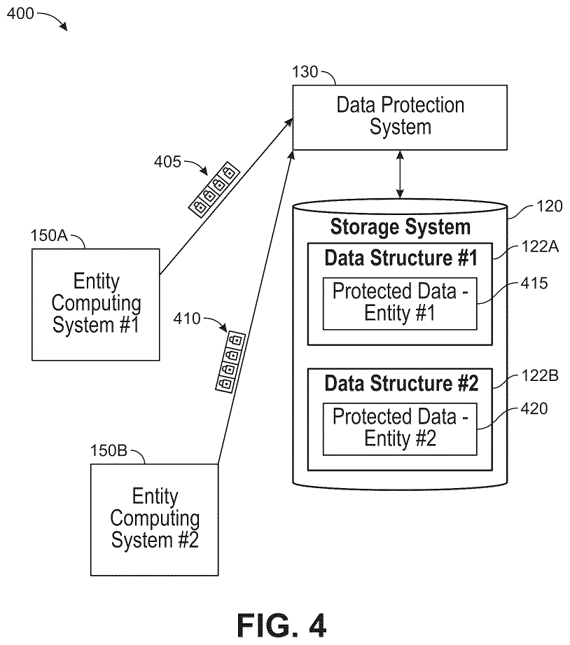

Referring now to FIG. 4, a block diagram further illustrating the protection architecture 100 of FIG. 1, according to some arrangements. Entity computing system 150A and 150B are described in detail with reference to entity computing system 150 of FIG. 1. It should be understood that entity computing systems 150A and 150B can also be third-party entity computing systems 140 of FIG. 1. Additionally, the data protection system 110 and storage system 120 is described in detail with reference to FIG. 1. As shown, entity computing system 150A can transmit protected data 405 to the data protection system 130 and entity computing system 150B can transmit protected data 410 to the data protection system 130. In some arrangements, the data protection system 130 can access the entity computing systems 150A-B to obtain or retrieve the protected data 405 and 410. The entity protection system 130 (e.g., data manager 116) can process the protected data and store the protected data into data structures 122A and 122B of storage system 120. For example, data structure 122A can include at least protected data 415 of entity computing system 150A. In this example, the protected data 415 could be transaction histories and customer personal identification information, which is normally used by the entity computing system 150A to perform BillPay. In another example, data structure 122 can include at least protected data 420 of entity computing system 150B. In this example, the protected data 420 could be detailed financial records and proprietary business intelligence, which is normally used by the entity computing system 150B to process or pay accounts receivables.

Accordingly, instead of the entity computing systems 150A and 150B maintaining and storing the protected data 405 and 410 the data protection system and storage system 120 can store, update, and maintain the protected data to generate trend maps and reports based on requests. In some arrangements, the data protection system 130 protects the entities (e.g., vendor, client, user) sensitive data by implementing encryption methods, access controls, and continuous monitoring for access patterns or potential security breaches. For example, employing cryptographic techniques and multi-factor authentication can improve data security by granting authorized individuals access to sensitive data, significantly reducing the risk of data theft or leakage. Additionally, the protection improves the entities' compliance with global data protection regulations, as the centralized management of sensitive information improves the adherence to GDPR, CCPA, and other privacy laws. In another example, by aggregating and anonymizing data where possible, the data protection system 130 can enhance privacy while still allowing for the extraction of valuable insights and trends.

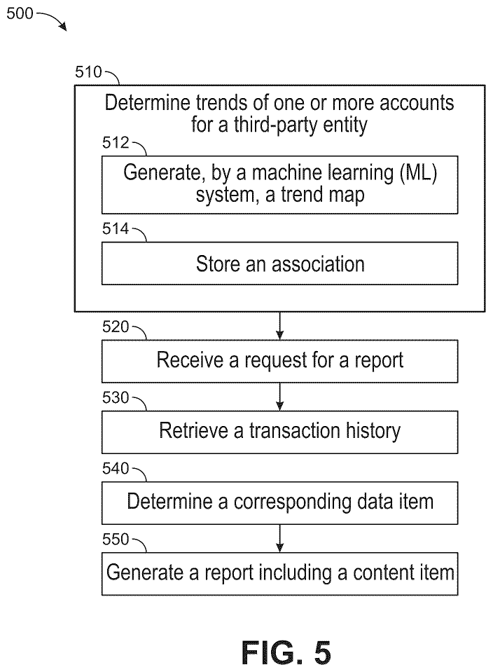

Referring now to FIG. 5, a flowchart for a method 500 of global modeling is shown, according to some embodiments. The computing systems and nodes of FIG. 1 can be configured to perform method 500. Further, any computing device described herein can be configured to perform method 500.

In broad overview of method 500, at block 510, the one or more processing circuits can determine trends of one or more accounts for a third-party entity. At block 520, the one or more processing circuits can receive a request for a report. At block 530, the one or more processing circuits can retrieve a transaction history. At block 540, the one or more processing circuits can determine a corresponding data item. At block 550, the one or more processing circuits can generate a report including a content item. Additional, fewer, or different operations may be performed depending on the particular arrangement. In some arrangements blocks can be optionally executed (e.g., blocks depicted as dotted lined) by the one or more processors. Additional, fewer, or different operations may be performed depending on the particular arrangement. In some embodiments, some, or all operations of method 500 may be performed by one or more processors executing on one or more computing devices, systems, or servers. In various embodiments, each operation may be re-ordered, added, removed, or repeated.

In some arrangements, a first data structure operated by the processing circuits can maintain a first dataset, the first dataset including, for a plurality of entities, an entity name, and an entity identifier. For example, the first dataset can be structured as a relational database including key-value pairs where each entity's name is associated with a unique identifier. That is, the first data structure can facilitate lookup and verification of entity identities during transactions. Additionally, a second data structure operated by the processing circuits can securely maintain a second dataset, the second dataset including, for the plurality of entities, one or more accounts associated with the entity. For example, the second dataset can be organized as an encrypted storage solution including account details and transaction histories for each entity. That is, the second data structure can protect the confidentiality and integrity of financial information. Accordingly, the first data structure and the second data structure can be used to model and generate secure and efficient data access protocols.

Additionally, the processing circuits can train, retrain, and implement one or more ML models. In some arrangements, at least one first ML model can be trained and implemented to match third-party entities with corresponding data items of the first dataset and determine a predicted account of the plurality of accounts for a corresponding transaction. For example, the first ML model can be trained and implemented to utilize pattern recognition and predictive analytics to forecast which accounts are likely to be used in upcoming transactions based on historical data. In this example, predictive analytics of the model can be used to provide maps into future transaction trends and account usage. In some arrangements, at least one second ML model can be trained and implemented to generate the content item identifying one or more recommendations. For example, the second ML model can be a GAI model trained and implemented to analyze transaction data and generate optimization strategies for exchange processing. In this example, generative algorithm can facilitate the creation of recommendations that improve transaction efficiency and security.

At block 510, the one or more processing circuits determine trends corresponding to the one or more accounts for a third-party entity of the plurality of entities and transaction types, wherein. Generally, the processing circuits can analyze data to determine a landscape view of vendors (e.g., what accounts are they using, what payment types are the using, and for what transactions). In some arrangements, the first ML model can be used to determine the trends.

In some arrangements, determining trends can include generating (at block 512), by a ML model (e.g., ML system or modeler), a trend map associated with the third-party entity according to a set of trend indicators determined for the third-party entity. That is, the trend map can identify trends corresponding to the one or more accounts for the third-party entity and transaction types. For example, the trend map can illustrate the frequency and volume of transactions processed through each account, generating preferred transaction methods and periods of high activity. In another example, the trend map can generate new patterns in payment method selection, such as an increased use of digital wallets over traditional bank transfers. Furthermore, at block 512, the generation during the trend determination can include aggregating and analyzing transaction data across multiple time periods to identify shifts in transaction behavior or account usage. For example, applying data clustering techniques to group similar transaction types and identify outliers in payment behaviors.

In some arrangements, at block 510, generating the trend map can be responsive to retrieving a plurality of data entries, determining a match score, and determine a trend indicator. In some arrangements, retrieving a plurality of data entries can include the processing circuits retrieving, from a respective enterprise resource of at least some of the plurality of entries, a plurality of data entries corresponding to transactions between a respective entity and a plurality of third-party entities. Furthermore, each data entry can include transaction information for the transaction and identifying information relating to a respective third-party entity. That is, retrieving can include querying database systems to compile a dataset that captures all relevant interactions between entities and third-party vendors, including date, amount, and method of payment. For example, the processing circuits can utilize data extraction tools or applications to pull transaction details from cloud-based ERP systems. In another example, the processing circuits can apply data normalization processes to standardize transaction information from diverse formats for analysis. After retrieving, the processing circuits can execute a match score determination process based on evaluating the consistency and frequency of transactions with specific third-party entities.

Additionally, the processing circuits can determine a match score between each third-party entity and a corresponding data item of the first dataset, based on the identifying information for the data entry for the respective third-party entity. That is, determining can include comparing transaction patterns and vendor identifiers against a historical database to assess the likelihood of future engagements. For example, the match score can be calculated using a weighted algorithm that considers the frequency of transactions, transaction volume, and recency of interactions. In another example, the match score can be adjusted based on anomalies detected in transaction patterns, indicating potential risks or changes in vendor relationships. Accordingly, the match score can influence the prioritization of vendors in future transaction planning.

In some arrangements, responsive to the match score satisfying a threshold criteria the processing circuits can generate a data item corresponding to the respective third-party entity for storage in the second data structure, the data item including information corresponding to an account used in a transaction with the third-party entity. The threshold criteria may function as a benchmark for engagement levels, filtering entities such that those with a history of substantial and consistent dealings are factored into analyses. For example, this criterion may be configured to include vendors whose transactional behavior aligns with the entity's risk management and operational efficiency goals. The resultant data item might then be an aggregated profile detailing financial interactions, inclusive of identifiers for account types, chronological transaction logs, financial sums, and preferred transaction mechanisms.

Moreover, the processing circuits can determine, for a data entry of the plurality of entries, a trend indicator for the third-party entity, the trend indicator identifying an account and a transaction type. That is, determining can include analyzing transaction history and payment methods to forecast future transaction preferences and potential shifts in vendor usage. For example, the trend indicator can be a predictive score reflecting the likelihood of using a specific payment method for future transactions based on past behavior. In another example, the trend indicator can highlight areas of potential fraud or security risks by flagging unusual patterns in account use or transaction types. Accordingly, the trend indicator can inform technical protection strategies and operational adjustments. After determining, the processing circuits can generate the trend map. In some arrangements, the trend map visualizes transaction frequencies, preferred payment methods, and protection indicators to inform strategic decision-making.

Additionally, at block 510, determining can include storing (at block 514) an association between the trend map and the corresponding data item for the third-party entity in the first dataset. In some arrangements, storing an association can include updating the relational database (e.g., data structures 122 of storage system 120 of FIG. 1) to include references between each vendor's trend data and their unique identifier within the dataset. For example, this could include embedding foreign keys within the trend map data structure that link back to specific vendor records in the entity dataset. In some arrangements, storing can link the landscape view for the vendor to the vendor identifying information in the first directory, such that once the processing circuits determine that a particular vendor is being used by a customer, the processing circuits can provide recommendations to the customer. That is, the process includes enriching vendor profiles with predictive analytics derived from the trend map. For example, this enriched data can allow protection systems to protect data while suggesting vendors based on transaction efficiency, cost-effectiveness, or risk profile, influencing purchasing strategies and vendor management practices.

Referring to the first ML model generally, the first ML model can be trained and executed by the processing circuits to perform block 510. As described above, the first ML model can retrieve data entries, determine a match, determine a trend indicator, generate a trend map, and store an association. In some arrangements, this process relates to the first ML model adapting its analysis based on real-time data inputs, refining its predictive accuracy over time. For example, generating the trend map based on one or more of the previous steps can include iterative learning processes where the first ML model adjusts its parameters in response to newly identified trends and anomalies. In this example, the first ML model's adaptive learning is improved to forecast emerging exchange patterns and vendor preferences. In some arrangements, the first ML model can dynamically update its analysis and recommendations.

Generally, blocks 520-550 can be performed by a second ML model configured to output a report based on various inputs. In some arrangements, the second ML model can be a GAI model configured to extrapolate existing data trends to predict future transactional behaviors. For example, the second ML model can generate a report base on a request that includes various content items corresponding to information of the trend map. In this example, the second ML model may use these predictions to highlight areas for potential data protection or efficiency improvements. Furthermore, the second ML model can refine its predictions over time as more data becomes available.

At block 520, the processing circuits can receive, from a user device associated with a first entity of the plurality of entities, a request for a report for a plurality of transactions of the first entity with a subset of the plurality of third-party entities. In some arrangements, receiving can include interpreting user input commands through a GUI to formulate the data retrieval request. For example, the request may be initiated by a user selecting specific vendors via a dropdown menu in the GUI. In another example, the processing circuit can automatically prompt the user for a report generation based on pre-set intervals or event triggers.

At block 530, the processing circuits can retrieve, from an enterprise resource of the first entity, a transaction history for the plurality of transactions with the subset of third-party entities, the transaction history including identifying information relating to a respective third-party entity of the subset. That is, retrieving can include pulling AR/transaction information from an ERP or other enterprise resource. For example, the retrieval process may employ data mining to generate an aggregation of transaction data. In some arrangements, the transaction history can include a payment type for each of the plurality of transactions. For example, the transaction history can include a ledger entry for each of the plurality of transactions, providing a full audit trail.

At block 540, the processing circuits can determine, for each of the subset of third-party entities, the corresponding data item in the first dataset. In some arrangements, determining can include querying the first data structure with parameters specific to each third-party entity to retrieve related data items. For example, the process may utilize SQL queries that filter results based on the entity's unique identifier and transactional history. That is, corresponding data can be a set of linked records that detail the third-party entity's profile, including past transactions and associated account details. In another example, determining can include using a matching algorithm to match third-party entity identifiers with transaction records to create a consolidated view of their financial interactions.

At block 550, the processing circuits can generate, using the second ML model, the report according to the request, the report including a content item including information corresponding to the trend map for the subset of third-party entities. In some arrangements, the content item can be generated on a graphical user interface (GUI) presented on a user device. For example, the report can include content items that can present an analysis of payment practices across different vendors. In another example, the content item could be a predictive model output identifying the likelihood of future transaction types with each vendor.

In some arrangements, generating the report can include determining, based on to the trend map for the respective third-party entity of the plurality of entities, a previous payment type used in prior transactions of the respective third-party entity. For example, when vendor X is using electronic payments, flags or actions can be reported to customer that they should enroll in electronic payments with that vendor. In another example, the report could identify the adoption of newer payment technologies by the third-party entity. That is, the previous payment type can be cataloged based on transaction frequency and recency. Additionally, the processing circuits can determine, based on a subset of the transactions between the first entity and the respective third-party entity, the payment type used for the subset of transactions. For example, the report could indicate a shift from traditional payment methods to digital or real-time payments. That is, the payment type can be classified by the transaction velocity it permits.

Furthermore, the processing circuits can generate the report to identify usage by the respective third-party entity of the previous payment type. For example, the report could identify a consistent use of wire transfers by the third-party entity in contrast to the industry trend of shifting towards electronic payments. In some arrangements, the processing circuits can transmit, to a device corresponding to the respective third-party entity, an enrollment request for the previous payment type for one or more future transactions between the first entity and the respective third-party entity. That is, the processing circuits can send requests to enroll entities in electronic payments to vendor on behalf of customer. For example, the processing circuits could facilitate the enrollment process through automated electronic communication, such as email or in-app notifications. In another example, the process could include interactive dialogue boxes on the user's device prompting for confirmation. Thus, an enrollment request can facilitate the transition to preferred payment methods.

In some arrangements, the processing circuits can also determine at least one of the one or more accounts for the respective third-party entity is maintained by the system of a provider. That is, when accounts of different entities are maintained by the provider, an on-us exchange can occur. For example, the on-us logic can include checking the account database for internal account markers. In another example, the on-us logic could include parsing the transaction histories to identify those accounts that are internal to the provider's system. In some arrangements, the determining can include the use of machine learning algorithms to predict and verify the account's eligibility for on-us transactions.

Additionally, the processing circuits can (1) transmit, to the user device of the first entity, a request to initiate a future payment, using the system of the provider, for a future payment type based on the report and (2) transmit, to the device of the respective third-party entity, the request to initiate the future payment, using the system of the provider, for the future payment type based on the report. That is, the transactions can be prompted through an automated system that suggests an improved efficient payment route based on the report. For example, the processing circuits could use the report to advise on optimal transaction timings. In another example, the suggestion could include prompts for bulk transactions to streamline processes.

Furthermore, the processing circuits, responsive to receiving an acceptance of the request to initiate the future payment from at least one of the first entity or the respective third-party entity, can process an on-us payment corresponding to the future payment type by the provider. In some arrangements, the on-us payment can bypass conventional banking channels to facilitate direct account-to-account transfers. That is, the transactions can be pre-validated to identify a match with the internal accounts before execution. For example, the transaction process could include a real-time balance check to prevent overdrafts. Accordingly, by having payments through the processing circuits, it reduces the likelihood of fraud, improve transaction processing, and improves efficiency through internal transfers as opposed to, for example, check or wire transfers.

In some arrangements, the report can include, for the respective third-party entity, one or more identifiers corresponding to an account of the one or more accounts of the third-party entity maintained in the second data structure, the one or more identifiers indicating a transaction type used for transactions with the account. For example, the report can include a breakdown of transaction types associated with each identifier, providing a view of the entity's financial engagements. In another example, the report could identify trends in the entity's payment behaviors, such as an increased reliance on certain transaction types.

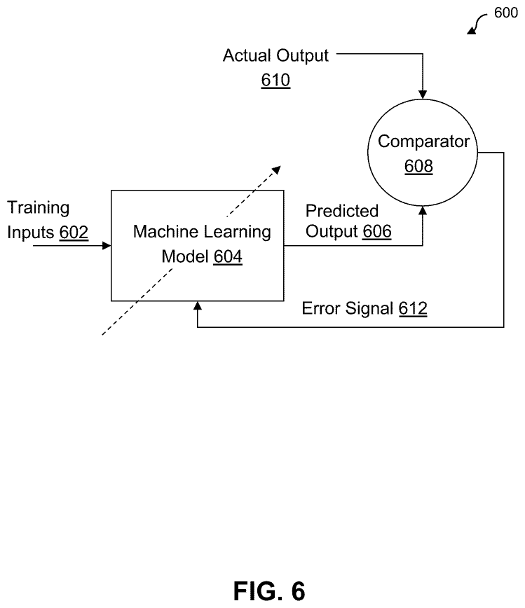

Referring to FIG. 6, a block diagram of an example system using supervised learning, is shown. Supervised learning is a method of training a machine learning model given input-output pairs. An input-output pair is an input with an associated known output (e.g., an expected output).

Machine learning model 604 may be trained on known input-output pairs such that the machine learning model 604 can learn how to predict known outputs given known inputs. Once the machine learning model 604 has learned how to predict known input-output pairs, the machine learning model 604 can operate on unknown inputs to predict an output.

The machine learning model 604 may be trained based on general data and/or granular data (e.g., data structures 122 stored in storage system 120) such that the machine learning model 604 may be trained specific to data structures 122.

Training inputs 602 and actual outputs 610 may be provided to the machine learning model 604. For example, training inputs 602 may include a first data structure including a first dataset. The first dataset can include data of a plurality of entities, an entity name, and an entity identifier, and the like.

The inputs 602 and actual outputs 610 may be received from computing systems and data sources of FIG. 1. For example, a data repository may contain data structures. The data repository may also contain sensitive data associated with entities and third-party entities. Thus, the machine learning model 604 may be trained to predict third-party entities with corresponding data items based on the training inputs 602 and actual outputs 610 used to train the machine learning model 604.

The data protection system 110 may include one or more machine learning models 604. In an embodiment, a first machine learning model 604 may be trained to predict trend maps given accounts information of various entities and exchange information. For example, the first machine learning model 604 may use the training inputs 602 to predict outputs 606, by applying the current state of the first machine learning model 604 to the training inputs 602. The comparator 608 may compare the predicted outputs 606 to actual outputs 610 (e.g., trends or previous reports) to determine an amount of error or differences. For example, the predicted trend map (e.g., predicted output 106) may be compared to the actual trend maps (e.g., actual output 110).

In other embodiments, a second machine learning model may be trained to predict reports given trend maps, exchange information, and corresponding data. For example, the second machine learning model may use the training inputs 602 to predict outputs 606, by applying the current state of the second machine learning model to the training inputs 602. The comparator 608 may compare the predicted outputs 606 to actual outputs 610 (e.g., reports) to determine an amount of error or differences.

The actual outputs 610 may be determined based on historic data of reports provided to the user 632 (e.g., entities). In an illustrative non-limiting example, actual outputs 610 could include historical transactional outcomes, such as payment completions or failure rates associated with specific vendors identified in the trend maps. In another illustrative non-limiting example, actual outputs 610 might include a record of vendor selection decisions made by the entities based on the previously generated reports or trend analyses.

During training, the error (represented by error signal 612) determined by the comparator 608 may be used to adjust the weights in the machine learning model 604 such that the machine learning model 604 changes (or learns) over time. The machine learning model 604 may be trained using a backpropagation algorithm, for instance. The backpropagation algorithm operates by propagating the error signal 612. The error signal 612 may be calculated each iteration (e.g., each pair of training inputs 602 and associated actual outputs 610), batch and/or epoch, and propagated through the algorithmic weights in the machine learning model 604 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 604 may be tuned to reduce the amount of error, thereby minimizing the differences between (or otherwise converging) the predicted output 606 and the actual output 610. The machine learning model 604 may be trained until the error determined at the comparator 608 is within a certain threshold (or a threshold number of batches, epochs, or iterations have been reached). The trained machine learning model 604 and associated weighting coefficients may subsequently be stored in memory 616 or other data repository (e.g., a database) such that the machine learning model 604 may be employed on unknown data (e.g., not training inputs 602). Once trained and validated, the machine learning model 604 may be employed during a testing (or an inference phase). During testing, the machine learning model 604 may ingest unknown data to predict future data (e.g., responses of entities to different exchange processing changes, and the like).

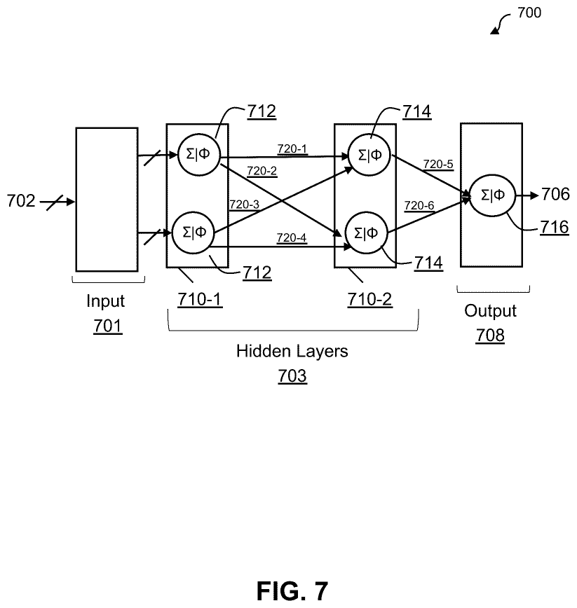

Referring to FIG. 7, a block diagram of a simplified neural network model 700 is shown. The neural network model 700 may include a stack of distinct layers (vertically oriented) that transform a variable number of inputs 702 being ingested by an input layer 704, into an output 706 at the output layer 708.

The neural network model 700 may include a number of hidden layers 710 between the input layer 704 and output layer 708. Each hidden layer has a respective number of nodes (712, 714 and 716). In the neural network model 700, the first hidden layer 710-1 has nodes 712, and the second hidden layer 710-2 has nodes 714. The nodes 712 and 714 perform a particular computation and are interconnected to the nodes of adjacent layers (e.g., nodes 712 in the first hidden layer 710-1 are connected to nodes 714 in a second hidden layer 710-2, and nodes 714 in the second hidden layer 710-2 are connected to nodes 716 in the output layer 708). Each of the nodes (712, 714 and 716) sum up the values from adjacent nodes and apply an activation function, allowing the neural network model 700 to detect nonlinear patterns in the inputs 702. Each of the nodes (712, 714 and 716) are interconnected by weights 720-1, 720-2, 720-3, 720-4, 720-5, 720-6 (collectively referred to as weights 720). Weights 720 are tuned during training to adjust the strength of the node. The adjustment of the strength of the node facilitates the neural network's ability to predict an accurate output 706.

In some embodiments, the output 706 may be one or more numbers. For example, output 706 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A system comprising:
a first data structure configured to maintain a first dataset, the first dataset comprising, for a plurality of entities, an entity name, and an entity identifier;
a second data structure configured to securely maintain a second dataset, the second dataset comprising, for the plurality of entities, one or more accounts associated with an entity;
a machine learning (ML) system; and
a processing circuit comprising one or more processors and memory storing instructions that, when executed, cause the processing circuit to:
determine trends corresponding to the one or more accounts for a third-party entity of the plurality of entities and transaction types, wherein, to determine the trends, the processing circuit is configured to:
generate, by the ML system, a trend map associated with the third-party entity according to a set of trend indicators determined for the third-party entity, the trend map identifying trends corresponding to the one or more accounts for the third-party entity and transaction types; and
store an association between the trend map and corresponding data item for the third-party entity in the first dataset;
receive, from a user device associated with a first entity of the plurality of entities, a request for a report for a plurality of transactions of the first entity with a subset of third-party entities;
retrieve, from an enterprise resource of the first entity, a transaction history for the plurality of transactions with the subset of third-party entities, the transaction history including identifying information relating to a respective third-party entity of the subset;
determine, for each of the subset of third-party entities, the corresponding data item in the first dataset; and
generate, by the ML system, the report according to the request, the report comprising a content item including information corresponding to the trend map for the subset of third-party entities.

2. The system of claim 1, further comprising:
a storage system configured to store the first data structure and the second data structure; and
wherein the ML system comprises at least one first ML model trained to match third-party entities with corresponding data items of the first dataset and determine a predicted account of the one or more accounts for a corresponding transaction, and at least one second ML model trained to generate the content item identifying one or more recommendations.

3. The system of claim 1, wherein the transaction history comprises a payment type for each of the plurality of transactions, and wherein to generate the report, the ML system is configured to:
determine, based on to the trend map for the respective third-party entity of the plurality of entities, a previous payment type used in prior transactions of the respective third-party entity;
determine, based on a subset of the plurality of transactions between the first entity and the respective third-party entity, the payment type used for the subset of plurality of transactions; and
generate the report to identify usage by the respective third-party entity of the previous payment type.

4. The system of claim 3, wherein the instructions further cause the processing circuit to:
transmit, to a device corresponding to the respective third-party entity, an enrollment request for the previous payment type for one or more future transactions between the first entity and the respective third-party entity.

5. The system of claim 4, wherein the instructions further cause the processing circuit to:
determine at least one of the one or more accounts for the respective third-party entity is maintained by the system of a provider;
transmit, to the user device of the first entity, a request to initiate a future payment, using the system of the provider, for a future payment type based on the report;
transmit, to the device of the respective third-party entity, the request to initiate the future payment, using the system of the provider, for the future payment type based on the report; and
responsive to receiving an acceptance of the request to initiate the future payment from at least one of the first entity or the respective third-party entity, process an on-us payment corresponding to the future payment type by the provider.

6. The system of claim 1, wherein the report comprises, for the respective third-party entity, one or more identifiers corresponding to an account of the one or more accounts of the third-party entity maintained in the second data structure, the one or more identifiers indicating a transaction type used for transactions with the account.

7. The system of claim 1, wherein generating the trend map comprises the processing circuit being further configured to:
retrieve, from a respective enterprise resource of at least some of a plurality of entries, a plurality of data entries corresponding to transactions between a respective entity and a plurality of third-party entities, each data entry including transaction information for the transaction and identifying information relating to a respective third-party entity;

8. The system of claim 7, wherein generating the trend map, responsive to retrieving the plurality of data entries, comprises the processing circuit being further configured to:
determine, by the ML system, a match score between each third-party entity and a corresponding data item of the first dataset, based on the identifying information for the each data entry for the respective third-party entity; and
determine, by the ML system, for a data entry of the plurality of entries, a trend indicator for the third-party entity, the trend indicator identifying an account and a transaction type.

9. The system of claim 8, wherein the processing circuit is further configured to, responsive to the match score satisfying a threshold criteria:
generate a data item corresponding to the respective third-party entity for storage in the second data structure, the data item including information corresponding to an account used in a transaction with the third-party entity.

10. A method of global modeling, the method comprising:
determining, by one or more processing circuits, trends corresponding to one or more accounts for a third-party entity of a plurality of entities and transaction types, wherein determining the trends comprises:
generating, using at least one first machine learning (ML) model, a trend map associated with the third-party entity according to a set of trend indicators determined for the third-party entity, the trend map identifying trends corresponding to the one or more accounts for the third-party entity and transaction types; and
storing an association between the trend map and corresponding data item for the third-party entity in a first dataset;
receiving, by the one or more processing circuits from a user device associated with a first entity of the plurality of entities, a request for a report for a plurality of transactions of the first entity with a subset of third-party entities;
retrieving, by the one or more processing circuits from an enterprise resource of the first entity, a transaction history for the plurality of transactions with the subset of third-party entities, the transaction history including identifying information relating to a respective third-party entity of the subset;
determining, by the one or more processing circuits for each of the subset of third-party entities, the corresponding data item in the first dataset; and
generating, by the one or more processing circuits using at least one second ML model, the report according to the request, the report comprising a content item including information corresponding to the trend map for the subset of third-party entities.

11. The method of claim 10, further comprising:
storing, by the one or more processing circuits, a first data structure comprising the first dataset, the first dataset comprising, for the plurality of entities, an entity name, and an entity identifier;
storing, by the one or more processing circuits, a second data structure comprising the second dataset, the second dataset comprising, for the plurality of entities, the one or more accounts associated with an entity; and
wherein the at least one first ML model is trained to match third-party entities with corresponding data items of the first dataset and determine a predicted account of the one or more accounts for a corresponding transaction, and the at least one second ML model is trained to generate the content item identifying one or more recommendations.

12. The method of claim 10, wherein the transaction history comprises a payment type for each of the plurality of transactions, and wherein to generate the report, the method further comprises:
determining, by the one or more processing circuits based on to the trend map for the respective third-party entity of the plurality of entities, a previous payment type used in prior transactions of the respective third-party entity;
determining, by the one or more processing circuits based on a subset of the plurality of transactions between the first entity and the respective third-party entity, the payment type used for the subset of plurality of transactions; and
generating, by the one or more processing circuits, the report to identify usage by the respective third-party entity of the previous payment type.

13. The method of claim 12, further comprising:
transmitting, by the one or more processing circuits to a device corresponding to the respective third-party entity, an enrollment request for the previous payment type for one or more future transactions between the first entity and the respective third-party entity.

14. The method of claim 13, further comprising:
determining, by the one or more processing circuits, at least one of the one or more accounts for the respective third-party entity is maintained by the system of a provider;
transmitting, by the one or more processing circuits to the user device of the first entity, a request to initiate a future payment, using the system of the provider, for a future payment type based on the report;
transmitting, by the one or more processing circuits to the device of the respective third-party entity, the request to initiate the future payment, using the system of the provider, for the future payment type based on the report; and
responsive to receiving an acceptance of the request to initiate the future payment from at least one of the first entity or the respective third-party entity, processing, by the one or more processing circuits, an on-us payment corresponding to the future payment type by the provider.

15. The method of claim 10, wherein the report comprises, for the respective third-party entity, one or more identifiers corresponding to an account of the one or more accounts of the third-party entity maintained in the second data structure, the one or more identifiers indicating a transaction type used for transactions with the account.

16. The method of claim 10, wherein generating the trend map comprises:
retrieving, by the one or more processing circuits from a respective enterprise resource of at least some of a plurality of entries, a plurality of data entries corresponding to transactions between a respective entity and a plurality of third-party entities, each data entry including transaction information for the transaction and identifying information relating to a respective third-party entity;

17. The method of claim 16, wherein generating the trend map, responsive to retrieving the plurality of data entries, the method further comprising:
determining, by the one or more processing circuits using the first ML model, a match score between each third-party entity and a corresponding data item of the first dataset, based on the identifying information for the each data entry for the respective third-party entity; and
determining, by the one or more processing circuits using the first ML model, for a data entry of the plurality of entries, a trend indicator for the third-party entity, the trend indicator identifying an account and a transaction type.

18. The method of claim 17, wherein responsive to the match score satisfying a threshold criteria, the method further comprising:
generating, by the one or more processing circuits. a data item corresponding to the respective third-party entity for storage in the second data structure, the data item including information corresponding to an account used in a transaction with the third-party entity.

19. A non-transitory computer readable medium (CRM) comprising one or more instructions stored thereon and executable by one or more processors to:
determine trends corresponding to one or more accounts for a third-party entity of a plurality of entities and transaction types, wherein determining the trends comprises:
generating, using at least one first machine learning (ML) model, a trend map associated with the third-party entity according to a set of trend indicators determined for the third-party entity, the trend map identifying trends corresponding to the one or more accounts for the third-party entity and transaction types; and
storing an association between the trend map and corresponding data item for the third-party entity in a first dataset;
receive, from a user device associated with a first entity of the plurality of entities, a request for a report for a plurality of transactions of the first entity with a subset of third-party entities;
retrieve, from an enterprise resource of the first entity, a transaction history for the plurality of transactions with the subset of third-party entities, the transaction history including identifying information relating to a respective third-party entity of the subset;
determine, for each of the subset of third-party entities, the corresponding data item in the first dataset; and
generate, using at least one second ML model, the report according to the request, the report comprising a content item including information corresponding to the trend map for the subset of third-party entities.

20. The non-transitory CRM of claim 19, having the one or more instructions stored thereon and executable by the one or more processors to:
store a first data structure comprising the first dataset, the first dataset comprising, for the plurality of entities, an entity name, and an entity identifier;
store a second data structure comprising the second dataset, the second dataset comprising, for the plurality of entities, the one or more accounts associated with an entity; and
wherein the at least one first ML model is trained to match third-party entities with corresponding data items of the first dataset and determine a predicted account of the one or more accounts for a corresponding transaction, and the at least one second ML model is trained to generate the content item identifying one or more recommendations.
